(19) United States
(12) Patent Application Publication
(10) Pub. No.: US 2023/0109862 A1
(43) Pub. Date: Apr. 13, 2023

(54) LINEAR PULSATING TYPE MAGNETIC MIXING SYSTEM AND AN ASSOCIATED METHOD OF OPERATION

(71) Applicant: GLOBAL LIFE SCIENCES SOLUTIONS USA LLC, Marlborough, MA (US)

(72) Inventors: Kandakumar Murugesan, Hoodi Village, Bengaluru (IN); Nagaraj Raghavendra Rao, Hoodi Village, Bengaluru (IN); Saravanan Balakrishnan, Hoodi Village, Bengaluru (IN)

(21) Appl. No.: 17/905,609

(22) PCT Filed: Apr. 1, 2021
(86) PCT No.: PCT/EP2021/058635

§ 371 Date: Sep. 2, 2022

(30) Foreign Application Priority Data
Apr. 2, 2020 (IN) 202041014749

(51) Int. Cl. B01F 33/453; B01F 31/44; B01F 31/441; B01F 35/513

(52) U.S. Cl. CPC B01F 33/4534; B01F 31/449; B01F 31/441; B01F 35/513; B01F 2101/44

(57) ABSTRACT

A mixing system (10) including a base module (12), a mixing unit (26), and an enclosure (14). The base module (12) includes a base support (16), a drive unit (18) disposed within the base support (16), a drive shaft (22) coupled to the drive unit (18), and a drive head (24) coupled to the drive unit (18) via the drive shaft (22) and disposed within the base support (16). The drive head (24) includes a first magnet (25). The mixing unit (26) includes a guide element (28) and an agitator (30) slidably coupled to the guide element (28). The agitator (30) includes a second magnet (32) and at least one vane (34). The enclosure (14) is coupled to the base support (16) encloses the guide element (28) and the agitator (30). The drive unit (18) and the drive head (24) are configured to generate a linear pulsating movement of the agitator (30) along the guide element (28) for mixing a fluid medium (47) within the enclosure (14).

### TECHNICAL FIELD

The present disclosure relates to mixing systems, and more particularly, to a pulsating type magnetic mixing system and an associated method using such a system. Furthermore, more specifically, a pulsating type magnetic mixing system used in a bioprocessing system is disclosed.

### BACKGROUND

Conventionally, mixing systems are used for the efficient mixing of powders, suspensions, solutions or emulsions. The mixing systems may be used for many industrial applications including bioprocessing industry, aviation industry, electronics industry, chemical industry, food industry, pharmaceutical industry, and the like. For example, for a bioprocessing industry, a bioreactor is used to process biological materials (for example, to grow plant, animal cells, or the like) including, for example, mammalian, plant or insect cells and microbial cultures. Some traditional bioreactors are designed as stationary pressurized vessels which can be mixed by several alternative means. Some other traditional bioreactors are designed as disposable bioreactors which utilize plastic sterile bags instead of a culture vessel made from stainless steel or glass.

A rocker bioreactor is a type of reactor having a platform on which a vessel/bag is placed, which provides movement around one or more axes by using an electrical motor. The rocker bioreactor generates a low shear environment for cells, as the cells are not directly exposed to fast moving tips of impeller blades. However, the rocking process is limited and cannot be utilized in a quick and efficient manner. Specifically, the rocking motion is limited to a low number of back and forth movements so as not to stress the system. Stirred tank bioreactors (STBRs) are reactors in which mixing has been accomplished in pressurized vessels/bags by internal mechanical agitation using impeller devices. An impeller device must provide sufficiently rapid agitation to disperse all compounds and achieve an effectively homogeneous concentration inside the bioreactor. The agitation is typically provided by a magnetically driven rotating impeller. During the storage of the culture medium, the requirement is to hold the particles of the culture medium in suspended state and thereby avoid settling of the particles. In stirrer-based bioreactors, settling of particles usually happens below the impeller devices due to suction force created due to stirring.

There is a need for an enhanced system which overcomes above-mentioned drawbacks associated with settling of particles during mixing of a fluid medium.

### SUMMARY OF THE INVENTION

In accordance with one embodiment of the present disclosure, a mixing system is disclosed. The mixing system includes a base module, a mixing unit, and an enclosure. The base module includes a base support, a drive unit disposed within the base support, a drive shaft coupled to the drive unit, and a drive head coupled to the drive unit via the drive shaft and disposed within the base support. The drive head includes a first magnet. The mixing unit includes a guide element and an agitator slidably coupled to the guide element. The agitator includes a second magnet and at least one vane. The enclosure is coupled to the base support and disposed enclosing the guide element and the agitator. The drive unit and the drive head are configured to generate a linear pulsating movement of the agitator along the guide element for mixing a fluid medium within the enclosure.

In accordance with another embodiment of the present disclosure, a method for operating a mixing system id disclosed. The method includes driving an agitator by a drive unit of a base module via a drive shaft and a drive head and generating a linear pulsating movement of the agitator along a guide element for mixing a fluid medium within an enclosure disposed enclosing the guide element and the agitator.

### BRIEF DESCRIPTION OF THE FIGURES

The disclosed system and method will be described and explained with additional specificity and detail with the accompanying figures in which:

FIG. 1 shows a schematic view of a mixing system 10 in accordance with one embodiment of the present disclosure;

FIG. 2 shows a schematic partial perspective view of the drive head 24, the drive shaft 22 and agitator 30 in accordance with the embodiment of FIG. 1;

FIG. 3a and FIG. 3b show schematic views of a mixing system 44 in accordance with another embodiment of the present disclosure;

FIG. 4 shows a schematic perspective view of the mixing system 10 in accordance with one embodiment of the present disclosure;

FIG. 5 is a schematic perspective view of the agitator 30 in accordance with an embodiment of the present disclosure;

FIG. 6 is a schematic perspective view of a vane 54 of an agitator in accordance with another embodiment of the present disclosure;

FIG. 7 is a schematic perspective view of the mixing system 10 in accordance with one embodiment of the present disclosure.

Further, persons skilled in the art to which this disclosure belongs will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having the benefit of the description herein.

### DETAILED DESCRIPTION OF THE EXEMPLARY EMBODIMENTS

For the purpose of promoting an understanding of the principles of the disclosure, reference will now be made to the embodiments illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying figures.

In accordance with the embodiments of the present disclosure, a mixing system is disclosed. The mixing system includes a base module having a drive unit disposed within a base support and a drive shaft coupled to the drive unit. The base module further includes a drive head coupled to the drive unit via the drive shaft and disposed within the base support. The drive unit includes a first magnet. The mixing system further includes a mixing unit having a guide element and an agitator slidably coupled to the guide element. The agitator includes a second magnet and at least one vane. The mixing system further includes an enclosure coupled to the base support and disposed enclosing the guide element and the agitator. The drive unit and drive head are configured to generate a linear pulsating movement of the agitator along the guide element for mixing a fluid medium within the enclosure.

In accordance with another embodiment, a method for operating a mixing system is disclosed. The method includes driving an agitator by a drive unit of a base module via a drive shaft and a drive head and generating a linear pulsating movement of the agitator along a guide element for mixing a fluid medium within an enclosure disposed enclosing the guide element and the agitator.

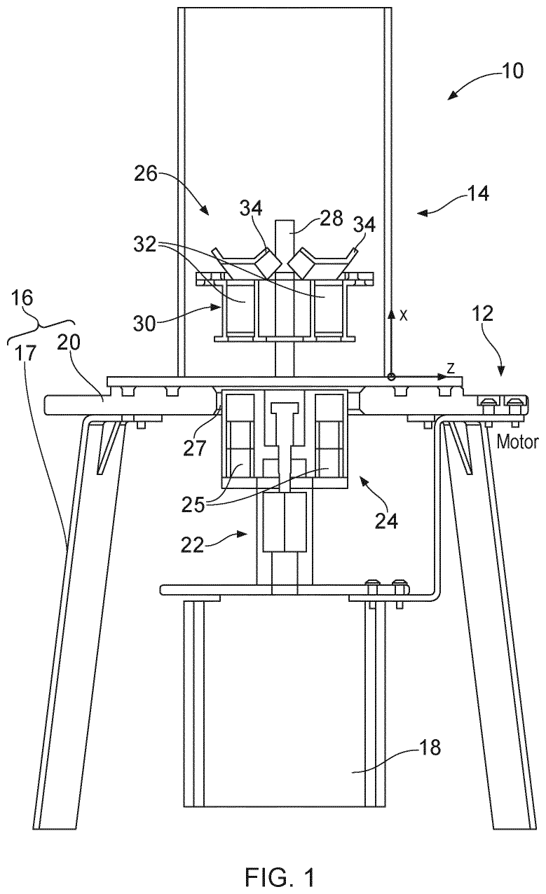

FIG. 1 shows a schematic perspective view of a mixing system 10 in accordance with one embodiment of the present disclosure. The mixing system 10 includes a base module 12 and an enclosure 14. In one embodiment, the enclosure 14 is a vessel, for example, a metallic vessel such as a stainless-steel vessel. The size of the vessel may vary depending on the application. In another embodiment, the enclosure 14 is a disposable bag, for example, a bioreactor bag. In one embodiment, the enclosure 14 is a pre-sterilized bag. In such an embodiment, the bag would be disposed inside a vessel.

The base module 12 includes a base support 16 and a drive unit 18 disposed within the base support 16. The base support 16 includes a plurality of support legs 17 and a support portion 20 coupled to the support legs 17. The enclosure 14 includes a mating connection device (not shown) coupled to a corresponding mating connection device (not shown) of the support portion 20. In one embodiment, a lower edge of the enclosure 14 may be coupled to a groove (not shown) formed in the support portion 20. Hence, the enclosure 14 is stably supported by the base support 16. In one particular embodiment, the enclosure 14 is a vessel having a cylindrical side wall having a plurality of side walls coupled to each other via a plurality of hinges. One side wall can be opened to access interior of the vessel for loading and unloading the pre-sterilized bag. The diameter of the cylindrical side wall may vary depending on the application. In another embodiment, the vessel may have a single integrated cylindrical side wall instead of a plurality of side walls. In one embodiment, the side walls may be manufactured by plastic injection molding. In one specific embodiment, thermoplastic material can be used for molding the side walls of the vessel. In another embodiment, the side walls of the vessel may be formed by stamping sheet metal or by 3D printing of either plastic or metal.

Furthermore, with reference to the hinges, opposite side edges of the side walls are provided with locking devices (not shown) so that the side walls can be detachably locked in a closed position. In one embodiment, the locking devices may include co-operating magnets provided on side edges of both the first and the second side walls. In another embodiment, the locking devices may include a snap lock or external standard latches to lock the side walls against each other in a closed position. In another embodiment, the vessel may have a side wall of different configuration, for example, a square shaped side wall instead of a cylindrical side wall. It should be noted herein that the vessel discussed herein in an exemplary embodiment and should not be construed as a limitation of the scope of the disclosure. Other suitable designs of the vessel are also envisioned within the scope of the disclosure.

The vessel may include one or more flexible heater pads (not shown) provided on an inner surface of the cylindrical side wall. The flexible heater pads are configured to heat the enclosure 14 when the enclosure is loaded within the vessel. In some embodiments, the flexible heater pads are provided symmetrically around the loaded enclosure. In one embodiment, the flexible heater pads are made of but not limited to silicone, polyimide, or other flexible heat-resistant polymers disposed enclosing electrical heating elements which typically may include conductive fibers or films. In some embodiments, the vessel can additionally include a flexible cooling jacket provided to the cylindrical side wall.

In one embodiment, the vessel includes a sensor support (not shown) coupled to cylindrical side wall. Sensors, such as but not limited to, for example, PH and dissolved oxygen sensors may be mounted to the sensor support.

As discussed earlier, the drive unit 18 is disposed within the base support 16. In the illustrated embodiment, the drive unit 18 is a rotary actuator such as a motor. The base module 12 further includes a drive shaft 22 coupled to the drive unit 18 and a drive head 24 coupled to the drive unit 18 via the drive shaft 22. The drive head 24 includes a plurality of first magnets 25. It should be noted herein that the drive head 24 is disposed within the base support 16. Specifically, the drive head 24 is disposed proximate to the support portion 20 of the base support 16. Further, it should be noted that the drive head 24 does not contact the support portion 20. In one embodiment, the drive head 24 is actuatably disposed partially within a recess 27 of the support portion 27.

The mixing system 10 further includes a mixing unit 26 having a guide element 28 and an agitator 30 slidably coupled to the guide element 28. In the illustrated embodiment, the guide element 28 is a guide shaft. The agitator 30 includes a plurality of second magnets 32 and a plurality of vanes 34. The enclosure 14 is disposed enclosing the guide element 28 and the agitator 30. Further, in one embodiment, the enclosure 14 is filled with a fluid medium such as but not limited to a culture medium used in a bioreactor. The drive unit 18 and the drive head 24 are configured to generate a linear pulsating movement of the agitator 30 along the guide element 28 for mixing the fluid medium within the enclosure 14. It may be noted herein that drive head 24 and the agitator 30 are not physically coupled to each other but can be magnetically coupled to each other during operation of the mixing system 10.

In one embodiment, the enclosure 14 may also include a sparger located below with reference to the agitator 30, for aeration of the fluid medium filled inside the enclosure 14. The agitation of the fluid medium provided by the agitator 30 facilitates distribution of air bubbles emanating from the sparger.

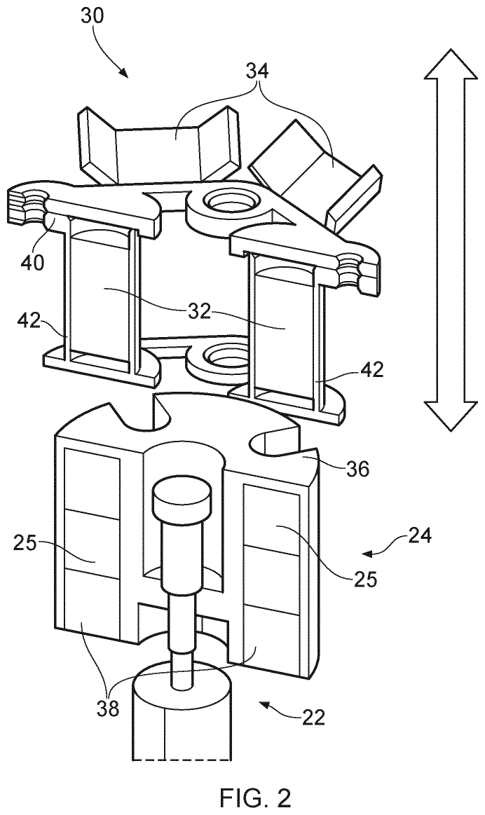

FIG. 2 shows a schematic partial perspective view of drive head 24, the drive shaft 22 and agitator 30 in accordance with the embodiment of FIG. 1. As discussed earlier, the drive unit 18 is disposed within the base support 16. The base module 12 further includes the drive shaft 22 coupled to the drive unit 18 and the drive head 24 coupled to the drive unit 18 via the drive shaft 22. The drive head 24 includes a first housing 36 having a plurality of first slots 38 and the plurality of first magnets 25 arranged in series disposed within the first slots 38. The number of first magnets 25 and the first slots 38 may vary depending on the application. Each first magnet 25 has a north pole (N) and a south pole (S). The plurality of first magnets 25 are arranged in series such that the poles having dissimilar polarities face each other (for example, N-S-N-S configuration).

The mixing unit 26 includes the guide element 28 and the agitator 30 slidably coupled to the guide element 28. In the illustrated embodiment, the guide element 28 is a guide shaft. In other embodiments, other configurations of the guide element 28 are envisioned. The agitator 30 includes a second housing 40 having a plurality of second slots 42 and the plurality of second magnets 32 disposed within the second slots 42. The number of second magnets 32, the second slots 42, and the guide elements 28 may vary depending on the application. Each second magnet 32 has a north pole (N) and a south pole (S). The plurality of first and second magnets 25, 32 are arranged such that the poles having same polarities face each other. Specifically, in one embodiment, the north pole (may also be referred to as first pole) of the adjacent first magnet 25 is disposed facing the north pole (may also be referred to as second pole) of the mutually adjacent second magnet 32 (N-N configuration). Further, the agitator 30 includes the plurality of vanes 34 coupled to the second housing 40. The enclosure 14 is disclosed enclosing the guide element 28 and the agitator 30. Further, in one embodiment, the enclosure 14 is filled with a fluid medium such as but not limited to a culture medium used in a bioreactor.

In one embodiment, the drive unit 18 is a rotary actuator such as a motor, for example. The drive unit 18 is configured to generate a rotary motion of the drive head 24, such that the drive head 24 rotates around a central axis of the drive shaft 22. During operation, when the drive unit 18 rotates the drive head 24, during certain time instances, the plurality of first magnets 25 would be aligned with the plurality of second magnets 32. As a result, the agitator 30 is pushed upwards along the guide element 28 within the enclosure 14 due to repelling magnetic force of the same polarities of the mutually adjacent first and second magnets 25, 32. During certain other time instances, the plurality of first magnets 25 would not be aligned with the plurality of second magnets 32. As a result, the agitator 30 is pushed downwards along the guide element 28 within the enclosure 14 due to the force of gravity. In this way, the drive unit 18 and the drive head 24 generate a linear pulsating movement of the agitator 30 along the guide element 28 for mixing the fluid medium within the enclosure 14. Specifically, the linear pulsating movement of the agitator 30 involves moving the agitator 30 upwards resulting in downward flow of the fluid medium and moving the agitator 30 downwards resulting in upward flow of the fluid medium. It may be noted herein that the drive unit 18 and the agitator 30 are not physically coupled to each other but can be magnetically coupled to each other during operation of the mixing system 10.

In another embodiment, the plurality of first magnets 25 are arranged in series such that the poles having dissimilar polarities face each other (for example, S-N-S-N configuration). In such an embodiment, the plurality of first and second magnets 25, 32 are arranged such that the poles having same polarities face each other. Specifically, in one embodiment, the south pole (may also be referred to as first pole) of the adjacent first magnet 25 is disposed facing the south pole (may also be referred to as second pole) of the mutually adjacent second magnet 32 (S-S configuration).

In one embodiment, the plurality of first and second magnets 25, 32 may be permanent magnets. In another embodiment, the plurality of first and second magnets 25, 32 may be electromagnets. In one particular embodiment, only one first magnet 25 and one second magnet may be 32 may be required. In other embodiments, the number of first and second magnets 25, 32 may vary depending on the application.

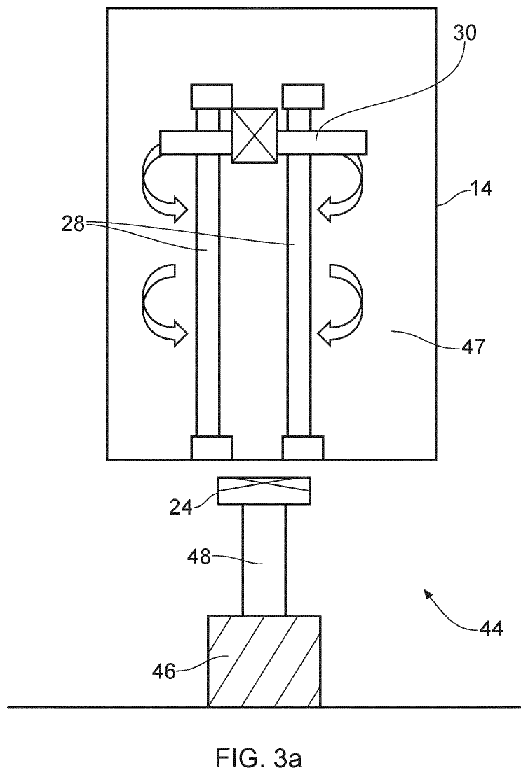

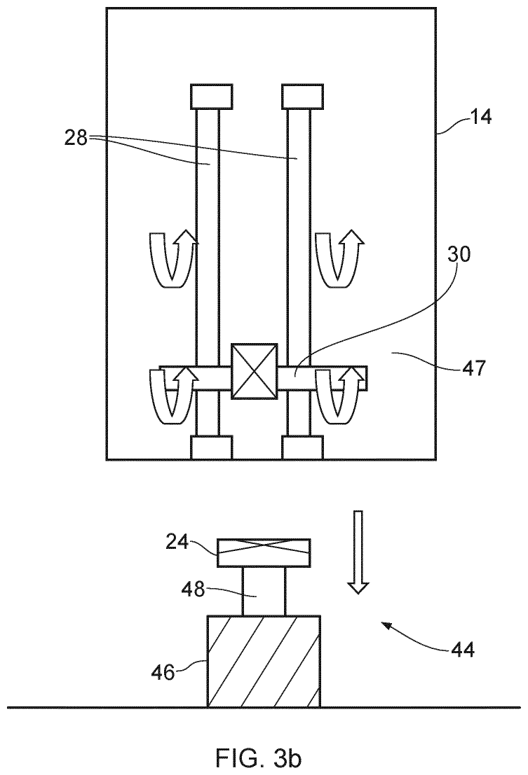

FIG. 3a and FIG. 3b show schematic views of a mixing system 44 in accordance with another embodiment of the present disclosure. The mixing system 44 includes a drive unit 46 disposed within a base support of a base module. The base module further includes a drive shaft 48 coupled to the drive unit 46 and the drive head 24 coupled to the drive unit 46 via the drive shaft 48. In the illustrated embodiment, the drive unit 46 is a linear actuator configured to generate a linear motion of the drive head 24. The drive head 24 has the plurality of first magnets arranged in series such that the poles having dissimilar polarities face each other (for example, N-S-N-S configuration).

The mixing unit 26 includes one or more guide elements 28 and the agitator 30 is slidably coupled to the one or more guide elements 28. As discussed earlier, the agitator 30 include the plurality of second magnets. The plurality of first and second magnets are arranged such that the poles having same polarities face each other. Specifically, in one embodiment, the north pole (may also be referred to as first pole) of the adjacent first magnet is disposed facing the north pole (may also be referred to as second pole) of the mutually adjacent second magnet (N-N configuration).

The drive unit 46 is configured to generate a linear motion of the drive head 24 via the drive shaft 48. During operation, when the drive unit 46 actuates the drive head 24 towards the agitator 30, the plurality of first magnets would be pushed towards the plurality of second magnets. As a result, the agitator 30 is pushed upwards along the one or more guide elements 28 within the enclosure 14 due to repelling magnetic force of the same polarities of the mutually adjacent first and second magnets (FIG. 3a). When the drive unit 46 actuates the drive head 24 away from the agitator 30, the plurality of first magnets would be pushed away from the plurality of second magnets. As a result, the agitator 30 is pushed downwards along the one or more guide elements 28 within the enclosure 14 due to the force of gravity (see, e.g., FIG. 3b). The drive unit 46 and the drive head 24 generates a linear pulsating movement of the agitator 30 along the guide element 28 for mixing the fluid medium 47 within the enclosure 14. Specifically, the linear pulsating movement of the agitator 30 involves moving the agitator 30 upwards resulting in downward flow of the fluid medium 47 and moving the agitator 30 downwards resulting in upward flow of the fluid medium 47.

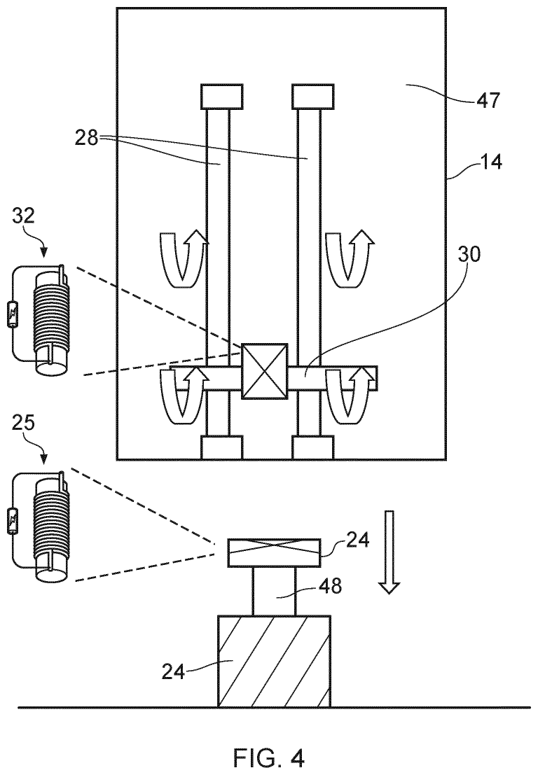

FIG. 4 shows a schematic perspective view of the mixing system 10 in accordance with one embodiment of the present disclosure. The drive head 24 includes the first housing having the plurality of first slots and the plurality of first magnets 25 arranged in series disposed within the first slots. In the illustrated embodiment, the plurality of first magnets 25 are electromagnets. An electromagnet is a type of magnet in which a magnetic field is produced by electric current fed from a source. The generated magnetic field disappears when supply of current is turned off from the source. Typically, an electromagnet includes a wire would around a coil.

The agitator 30 includes the second housing having the plurality of second slots and the plurality of second magnets 32 disposed within the second slots.

During operation, when the drive unit 46 actuates the drive head 24 towards the agitator 30, the plurality of first magnets 25 would be pushed towards the plurality of second magnets. The first magnets 25 would be magnetized by supplying electric current from an electrical source. As a result, the agitator 30 is pushed upwards along the one or more guide elements 28 within the enclosure 14 due to repelling magnetic force of the same polarities of the mutually adjacent first and second magnets 25, 32. When the drive unit 46 actuates the drive head 24 away from the agitator 30, the plurality of first magnets 25 would be pushed away from the plurality of second magnets 32. The first magnets 25 would be de-magnetized by stopping supply of electric current from the source. As a result, the agitator 30 is pushed downwards along the one or more guide elements 28 within the enclosure 14 due to the force of gravity. In one embodiment, the plurality of second magnets 32 are electromagnets similar to the first magnets 25.

Further, instead of driving the drive head 24 towards and away from the agitator 30, the drive head 24 can be stationary, and electricity can be supplied to the first magnets 25 at intervals. When the first magnets are provided electricity their magnetic force would repel the second magnets 32, and when the first magnets 24 are not provided with electricity they would not produce any magnetic force, and the agitator would fall due to the force of gravity. In such a configuration, the drive unit 46 and drive shaft 48 are not explicitly required, so long as the drive head 24 with associated first magnets 24 are fixedly located within the base.

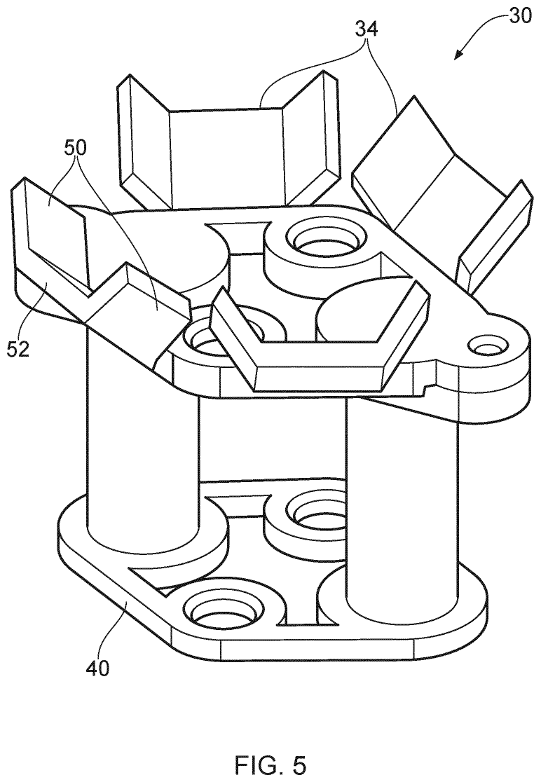

FIG. 5 is a schematic perspective view of the agitator 30 in accordance with an embodiment of the present disclosure. The agitator 30 includes the second housing 40 having the plurality of second slots and the plurality of second magnets disposed within the second slots. Further, the agitator 30 includes the plurality of vanes 34 coupled to the second housing 40. Each vane 34 includes a plurality of side portions 50 and a mid-portion 52. Each side portion 50 extends outward from the mid-portion 50 at a predefined angle. The number of vanes and the vane configuration may vary depending on the application.

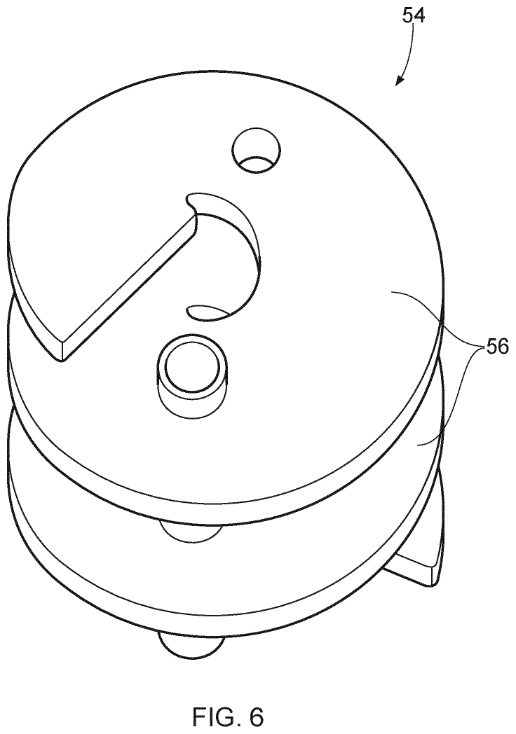

FIG. 6 is a schematic perspective view of a vane 54 of an agitator in accordance with another embodiment of the present disclosure. In the illustrated embodiment, the vane 54 has a coiled plate configuration. The vane 54 has a plurality of flat coiled portions 56.

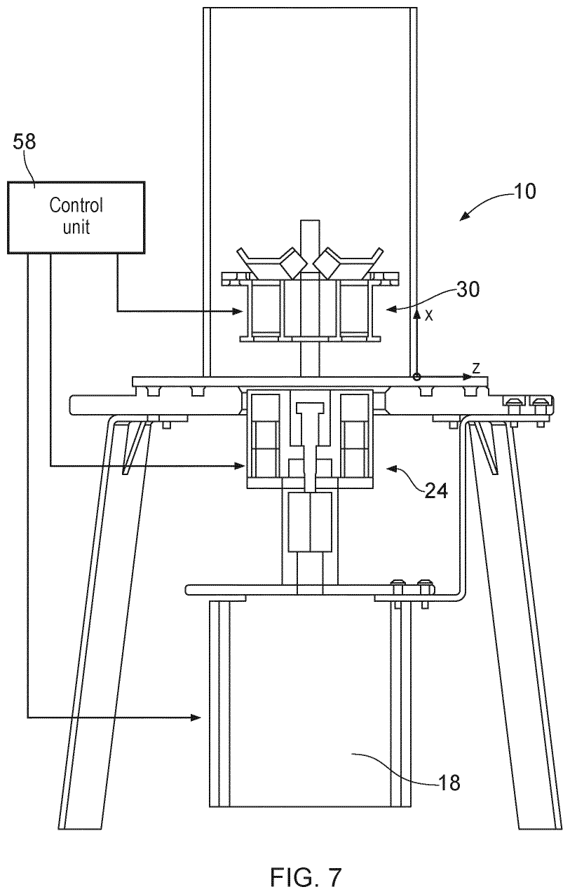

FIG. 7 is a schematic perspective view of the mixing system 10 in accordance with one embodiment of the present disclosure. In the illustrated embodiment, the mixing system 10 has a control unit 58 coupled to at least one of the drive unit 18, the drive head 24, and the agitator 30.

The control unit 58 is configured to control operation of the drive unit 18. In another embodiment, the control unit 58 is configured to control supply of current from the source to the first and second magnets 25, 32 respectively of the drive head 24 and the agitator 30 if the first and/or second magnets 25, 32 are electromagnets. In one embodiment, the control unit 58 may include at least one processor (not shown), an input/output (I/O) interface (not shown), and a memory (not shown). The at least one processor may be implemented as one or more microprocessors, microcomputers, microcontrollers, digital signal processors, central processing units, state machines, logic circuitries, and/or any device that manipulates signals based on operational instructions. Among other capabilities, the at least one processor is configured to fetch and execute computer-readable instructions stored in the memory.

The I/O interface may include a variety of client application and hardware interfaces, for example, a web interface, a graphical user interface, and the like. The I/O interface may allow the control unit 58 to interact with a customer directly or through customer devices. Further, the I/O interface may enable the control unit 58 to communicate with other computing devices such as web servers and external data servers (not shown). The I/O interface may facilitate multiple communications within a wide variety of networks and protocol types, including wired networks such as Local Area Network, cable, etc., and wireless networks such as Wireless Local Area Network, cellular, satellite, etc. The I/O interface may include one or more ports for connecting a plurality of devices to each other and/or to another server.

The memory may include any computer-readable medium known in the art, including, for example, volatile memory such as static random access memory (SRAM) and/or dynamic random access memory (DRAM) and/or non-volatile memory such as read only memory (ROM), erasable programmable ROM, flash memories, hard disks, optical disks, and/or magnetic tapes.

In accordance with the embodiments discussed herein, the drive unit and the drive head are configured to generating a linear pulsating motion of the agitator. The agitator is designed such a way that the upward motion of the agitator directs the flow of the fluid medium downwards and the downward motion of the agitator directs the flow of the fluid medium upwards to ensure complete mixing of the fluid medium.

1. A mixing system comprising:
a base module comprising:
a base support;
a drive unit disposed within the base support;
a drive shaft coupled to the drive unit; and
a drive head coupled to the drive unit via the drive shaft and disposed within the base support, wherein the drive head comprises a first magnet;
a mixing unit comprising:
a guide element; and
an agitator slidably coupled to the guide element, wherein the agitator comprises a second magnet and at least one vane;
an enclosure coupled to the base support and enclosing the guide element and the agitator,
wherein the drive unit and the drive head are configured to generate a linear pulsating movement of the agitator along the guide element for mixing a fluid medium within the enclosure.

2. The mixing system as claimed in claim 1, wherein the drive unit comprises a linear actuator configured to generate a linear motion of the drive head

3. The mixing system as claimed in claim 1, wherein the drive unit comprises a rotary actuator configured to generate a rotary motion of the drive head.

4. The mixing system as claimed in claim 1, wherein the first magnet is an electromagnet.

5. The mixing system as claimed in claim 1, wherein the first magnet is a permanent magnet.

6. The mixing system as claimed in claim 1, wherein the second magnet is an electromagnet.

7. The mixing system as claimed in claim 1, wherein the second magnet is a permanent magnet.

8. The mixing system as claimed in claim 1, wherein the first magnet comprises a first pole and the second magnet comprises a second pole disposed facing the first pole, and wherein the first and second poles have same polarities.

9. The mixing system as claimed in claim 1, wherein the at least one vane comprises a plurality of side portions and a mid-portion, wherein each side portional:4 extends outward from the mid portion at a predefined angle.

10. The mixing system as claimed in claim 1, wherein the at least one vane comprises a coiled plate configuration.

11. The mixing system as claimed in claim 1, wherein the enclosure is a pre-sterilized bag.

12. The mixing system as claimed in claim 11, further comprising a vessel coupled to the base support and disposed enclosing the pre-sterilized bag.

13. The mixing system as claimed in claim 1, wherein the enclosure is a vessel.

14. The mixing system as claimed in claim 1, wherein the mixing system is used in a bioprocessing system, and wherein the enclosure is filled with a culture medium.

15. The mixing system as claimed in claim 1, further comprising a control unit coupled to at least one of the drive unit the drive head, and the agitator.

16. A method for operating a mixing system, the method comprising:
driving an agitator by a drive unit of a base module via a drive shaft and a drive head;
wherein the drive unit and the drive head are disposed within a base support of the base module, wherein the drive head comprises a first magnet, and
wherein the agitator comprises a second magnet and at least one vane; and
generating a linear pulsating movement of the agitator along a guide element for mixing a fluid medium within an enclosure wherein the enclosure encloses the guide element and the agitator.

17. The method as claimed in claim 16, wherein generating the linear pulsating movement of the agitator comprises:
moving the drive head upwards towards the agitator to push the agitator upwards; and
moving the drive head downwards away from the agitator to move the agitator downwards, wherein the first magnet comprises a first pole and the second magnet comprises a second pole disposed facing the first pole, and wherein the first and second poles have the same polarity.

18. The method as claimed in claim 16, wherein generating the linear pulsating movement of the agitator comprises:
rotating the drive head to push the agitator upwards due to a repulsive magnetic force when the first magnet is aligned with second magnet and move the agitator downwards due to a gravitational force when the first magnet is not aligned with the second magnet, wherein the first magnet comprises a first pole and the second magnet comprises a second pole disposed facing the first pole, and wherein the first and second poles have same polarities.

19. The method as claimed in claim 16, wherein generating the linear pulsating movement of the agitator comprises moving the agitator upwards resulting in downward flow of the fluid medium and moving the agitator downwards resulting in upward flow of the fluid medium.

20. The method as claimed in claim 16, further comprising controlling operation of at least one of the drive unit, the drive head, and the agitator by a control unit.

21. The method as claimed in claim 16, wherein the fluid medium is a culture medium.
